(19) United States
(12) Patent Application Publication
(10) Pub. No.: US 2017/0260931 A1
(43) Pub. Date: Sep. 14, 2017

(54) Evaporative Emission Control System

(71) Applicants: DENSO International America, Inc., Southfield, MI (US); DENSO CORPORATION, Kariya-shi (JP)

(72) Inventors: Paolo GUIDI, Macomb, MI (US); Steven MUIR, LaSalle (CA)

(21) Appl. No.: 15/066,740

(22) Filed: Mar. 10, 2016

(51) Int. Cl. F02M 25/08; F02M 26/41; F02M 26/36

(52) U.S. Cl. CPC F02M 25/0836; F02M 26/36; F02M 26/41

(57) ABSTRACT

An evaporative emissions control system for an internal combustion engine having a plurality of cylinders including a dedicated exhaust gas recirculation (DEGR) cylinder. The evaporative emissions control system including a fuel tank vent line configured to direct fuel vapors evaporated from fuel within a fuel tank to only the DEGR cylinder of the plurality of cylinders. A purge valve is along the fuel vent line and is configured to control passage of fuel vapors to the DEGR cylinder.

### FIELD

The present disclosure relates to an evaporative emission control system, such as for an engine having a dedicated exhaust gas recirculation cylinder.

### BACKGROUND

This section provides background information related to the present disclosure, which is not necessarily prior art.

Vehicles are typically equipped with evaporative emission control (EVAP) systems to prevent gasoline vapors from escaping into the atmosphere from the fuel tank and fuel system. EVAP systems prevent the release of fuel vapors by sealing off the fuel system from the atmosphere. For example, vent lines from the fuel tank route vapors to an EVAP storage canister, where they are trapped and stored until the engine is started. When the engine is warm and the vehicle is in motion, the vehicle control module opens a purge valve allowing the vapors to be siphoned from the storage canister into the engine intake manifold. The fuel vapors are then burned in the engine. While current EVAP systems are suitable for their intended use, they are subject to improvement. For example, an improved EVAP system for use with an internal combustion engine having a dedicated exhaust gas recirculation cylinder would be desirable.

### SUMMARY

This section provides a general summary of the disclosure, and is not a comprehensive disclosure of its full scope or all of its features.

The present teachings provide for an evaporative emissions control system for an internal combustion engine having a plurality of cylinders including a dedicated exhaust gas recirculation (DEGR) cylinder. The evaporative emissions control system including a fuel tank vent line configured to direct fuel vapors evaporated from fuel within a fuel tank to only the DEGR cylinder of the plurality of cylinders. A purge valve is along the fuel vent line and is configured to control passage of fuel vapors to the DEGR cylinder.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of select embodiments and not all possible implementations, and are not intended to limit the scope of the present disclosure.

FIG. 1 illustrates an engine having a dedicated exhaust gas recirculation cylinder, and an evaporative emission control system in accordance with the present teachings.

Corresponding reference numerals indicate corresponding parts throughout the several views of the drawings.

### DETAILED DESCRIPTION

Example embodiments will now be described more fully with reference to the accompanying drawings.

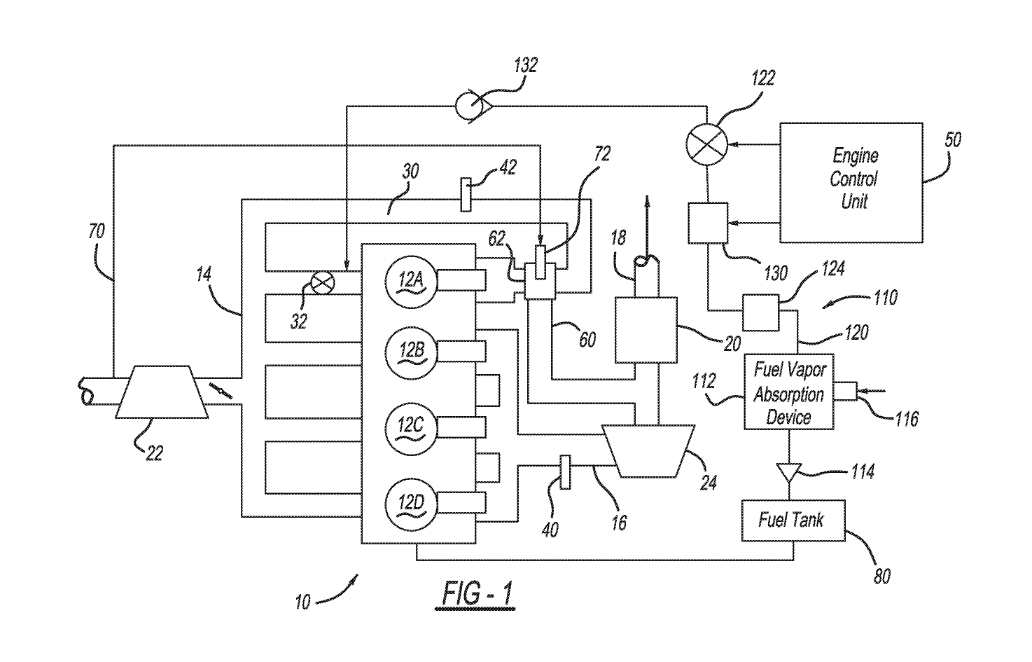

With initial reference to FIG. 1, an internal combustion engine is generally illustrated at reference numeral 10. The internal combustion 10 can be any suitable internal combustion engine configured to propel any suitable vehicle, such as, but not limited to, a passenger vehicle, mass transit vehicle, military vehicle, watercraft, aircraft, or any other suitable vehicle. The engine 10 is illustrated as having four cylinders 12A, 12B, 12C, and 12D, but can have any suitable number of cylinders. As further described herein, the cylinder 12A is a dedicated exhaust gas recirculation (DEGR) cylinder.

The engine 10 is spark-ignited, with each cylinder 12A-12D having an associated sparkplug (not shown), however the engine 10 can also be suitable for use with compression-ignited engines. The engine 10 further includes any suitable fuel delivery system for introducing fuel into the cylinders. The fuel delivery system can be any suitable system, such as fumigated, port injected, or direct injected.

The engine 10 further includes an intake manifold 14 configured to supply an air-fuel mixture to the cylinders 12A-12D. An exhaust manifold 16 directs exhaust from the engine 10 to a main exhaust line 18. Along the main exhaust line 18 is a catalytic converter 20. The engine 10 can also have a turbocharger, which can include a compressor 22 upstream of the intake manifold 14, and a turbine 24 in receipt of exhaust passing through the exhaust manifold 16.

The engine 10 further includes an exhaust gas recirculation (EGR) line 30, which directs exhaust exiting the DEGR cylinder 12A back to the intake manifold 14 for distribution to the cylinders 12A-12D. The flow of exhaust gas back to the cylinders 12A-12D can be regulated in any suitable manner. For example, the flow of exhaust gas back into the DEGR cylinder 12A can be regulated with an EGR valve 32, which can be arranged just upstream of the DEGR cylinder 12A, as illustrated in FIG. 1. The EGR valve 32 can be controlled by ECU 50 in order to supply a desired air/fuel and exhaust mixture to the DEGR cylinder 12A to run the DEGR cylinder 12A at a generally rich air/fuel/exhaust ratio. Any other device or control means can be used to control the flow of exhaust gas back into the DEGR cylinder 12A and the other cylinders 12B-12D, such as, but not limited to, variable valve timing. Although only one DEGR cylinder 12A is illustrated, the engine 10 can include more than one DEGR cylinder and any of the cylinders 12B-12D can be converted to a DEGR cylinder.

After entering the cylinders 12A-12D, the mixture of fresh air, recirculated exhaust gas, and fuel is ignited and combusts. After combustion, exhaust gas from cylinders 12B, 12C, and 12D flows through the respective exhaust ports and into the exhaust manifold 16. From the exhaust manifold 16, exhaust gas then flows through the turbine 24, which drives the compressor 22 of the turbocharger. From the turbine 24, exhaust gas flows to the catalytic converter 20, where the exhaust gas is treated before exiting to the atmosphere.

To facilitate control of the air/fuel ratio to the engine 10, the engine 10 may include one or more sensors configured to sample the air/fuel ratio of exhaust arranged at any suitable location about the engine 10. For example, the engine 10 may include a first sensor 40 arranged in the exhaust manifold 16, and a second sensor 42 arranged in the EGR line 30. Inputs from the sensors 40 and 42 can be directed to any suitable engine control unit 50.

The engine control unit 50 can be any suitable controller, such as any suitable processor hardware that executes code and memory hardware that stores code executed by the processor hardware, which is configured to operate the engine 10 to ensure optimal engine performance of the engine 10. For example, the engine control unit 50 is configured to determine the amount of fuel to inject into the engine 10 based on various sensor readings, such as readings of the first and second sensors 40 and 42. The first and second sensors 40 and 42 can be oxygen sensors, and inputs to the engine control unit 50 from the first and second sensors 40 and 42 can help the engine control unit 50 determine whether the engine is running rich (too much fuel or too little oxygen) or running lean (too much oxygen or too little fuel) as compared to ideal or stoichiometric conditions.

The engine control unit 50 is thus configured to set the air/fuel ratio of the DEGR cylinder 12A. It is often advantageous to run to the DEGR cylinder 12A with a rich stoichiometric air/fuel ratio to provide the engine 10 with a rich air/fuel ratio, which improves engine combustion. The engine control unit 50 can therefore be configured to control the EGR valve 32, and the amount of fuel injected into the cylinder 12A, in order to run the cylinder 12A with a rich stoichiometric air/fuel ratio.

The engine 10 further includes a bypass line 60, which provides a direct line of fluid communication for exhaust gas present in the EGR line 30 to an area of the main exhaust line 18 between the turbine 24 and the catalytic converter 20. To maximize heat of the exhaust gas in the bypass line 60, the bypass line 60 connects to EGR line 30 at a point proximate to the DEGR cylinder 12A, and connects to the main exhaust line 18 at a point upstream of the catalytic converter 20. A bypass valve 62 can be located where the bypass line 60 connects to the EGR line 30. The bypass valve 62 can be operated, such as by the engine control unit 50, to allow some or all of the exhaust gas in the EGR line 30 to be directed into the bypass line 60, instead of through the EGR line 30 and into the intake manifold 14. The hot exhaust gas from the bypass line 60 is used to warm the catalytic converter 20 during cold start conditions.

A secondary air line 70 extends from a portion of the intake manifold 14 upstream of the compressor 22 to the bypass line 60 in order to provide air (and particularly the O₂ thereof) to the bypass line 60. A secondary air valve 72 may be included where the secondary air line 70 is connected to the bypass line 60 in order to control the amount of air entering the bypass line 60. The secondary air valve 72 can be controlled by the engine control unit 50 for example.

The present teachings further provide for an evaporative emissions control (EVAP) system 110. The EVAP system 110 is configured to prevent fuel vapors evaporated from fuel in fuel tank 80 from escaping into the atmosphere. The EVAP system 110 includes a fuel vapor absorption device 112 configured to absorb fuel vapors exiting the fuel tank 80. The fuel vapor absorption device 112 can include a canister having charcoal or any other material suitable for absorbing fuel vapors. Between the fuel tank 80 and the fuel vapor absorption device 112 is a valve 114, which is configured to restrict liquid fuel from flowing therethrough. An air inlet 116 is provided to permit airflow into the fuel vapor absorption device 112 to allow air to mix with the fuel vapor therein. Extending from the fuel vapor absorption device 112, such as directly from the fuel vapor absorption device 112, is a fuel tank vent line 120. The fuel tank vent line 120 extends to the portion of the intake manifold 14 configured to supply air and exhaust to the DEGR cylinder 12A. For example, the fuel tank vent line 120 can extend to the EGR valve 32, or to a position between the EGR valve 32 and the DEGR cylinder 12A, or directly to the DEGR cylinder 12A.

Along the fuel tank vent line 120, downstream from the fuel vapor absorption device 112, is a purge valve 122. The purge valve 122 is configured to permit and regulate flow of fuel vapors to the portion of the intake manifold 14 leading only to the DEGR cylinder 12A. The purge valve 122 can be any suitable valve, such as a solenoid valve, and can be electronically operated by the engine control unit 50 in order to regulate the amount of fuel vapor directed to the DEGR cylinder 12A. A purge pump 124 can be arranged along the fuel tank vent line 120 either upstream or downstream from the purge valve 122. The purge pump 124 can be any suitable pump able to assist in purge flow into the DEGR cylinder 12A during high pressure conditions, such as when a turbocharger is active.

At any suitable position along the fuel tank vent line 120 can be a hydrocarbon (HC) sensor 130. In the example illustrated, the HC sensor 130 is positioned upstream of the purge valve 122. The HC sensor 130 can be any suitable sensor configured to generate outputs to the engine control unit 50 representing the amount of fuel vapor in the fuel tank vent line 120. A check valve 132 can also be included along the fuel tank vent line 120 at any suitable position, such as downstream of the purge valve 122 as illustrated. The check valve 132 is configured to restrict flow of the fuel/air mixture from the engine to the fuel tank 80 through the fuel tank vent line 120, such as during operation of the turbo charger.

Thus the fuel tank vent line 120 advantageously directs the fuel vapor evaporated from the fuel tank 80 only to the DEGR cylinder 12A, and not to the other cylinders 12B-12D. Because the DEGR cylinder 12A is typically run rich by the engine control unit 50 in order to facilitate chemical reactions with the other cylinders 12B-12D to provide optimal power and fuel consumption, directing the evaporated fuel vapor only to the DEGR cylinder 12A facilitates running the DEGR cylinder 12A at a rich air/fuel ratio to support the fundamental strategy of a DEGR combustion system. Concentrating the evaporated fuel vapor at the DEGR cylinder 12A also facilitates running the other cylinders 12B-12C at a precise stoichiometric air/fuel ratio. The engine control unit 50 is configured to control the amount of fuel vapor delivered to the DEGR cylinder 12A by way of the fuel tank vent line 120 by actuating the purge valve 122. The engine control unit 50 can also be configured to open the purge valve 122 when temperature of the engine 10 is greater than a predetermined threshold to allow fuel vapor collected in the fuel vapor absorption device 112 to exit the device 112 and be delivered to the DEGR cylinder 12A to be burned in the engine 10.

The description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used is for the purpose of describing particular example embodiments only and is not intended to be limiting. The singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). The term “and/or” includes any and all combinations of one or more of the associated listed items.

Although the terms first, second, third, etc. may be used to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An evaporative emissions control system for an internal combustion engine having a plurality of cylinders including a dedicated exhaust gas recirculation (DEGR) cylinder, the evaporative emissions control system comprising:
a fuel tank vent line configured to direct fuel vapors evaporated from fuel within a fuel tank to only the DEGR cylinder of the plurality of cylinders; and
a purge valve along the fuel tank vent line configured to control passage of fuel vapors to the DEGR cylinder.

2. The evaporative emissions control system of claim 1, further comprising a fuel vapor absorption device including a material configured to adsorb fuel vapors.

3. The evaporative emissions control system of claim 2, wherein the fuel tank vent line extends directly from the fuel vapor absorption device.

4. The evaporative emissions control system of claim 2, further comprising a check valve between the purge valve and the dedicated exhaust gas recirculation cylinder.

5. The evaporative emissions control system of claim 1, wherein the purge valve is an electronically operated solenoid valve controlled by an engine control unit.

6. The evaporative emissions control system of claim 1, further comprising an exhaust gas recirculation line configured to direct exhaust gas generated by the DEGR cylinder back to the plurality of cylinders.

7. The evaporative emissions control system of claim 1, further comprising a hydrocarbon sensor along the fuel tank vent line between the fuel vapor absorption device and the purge valve.

8. The evaporative emissions control system of claim 1, further comprising a controller configured to:
open the purge valve when engine temperature is greater than a predetermined threshold to direct fuel vapors to the dedicated exhaust gas recirculation cylinder to be burned by the internal combustion engine.

9. The evaporative emissions control system of claim 8, wherein:
the controller is configured to operate the purge valve to direct the fuel vapors to only the dedicated exhaust gas recirculation (DEGR) cylinder to run the DEGR cylinder at a rich stoichiometric air/fuel ratio; and
the controller is configured to run the plurality of cylinders other than the DEGR cylinder at a stoichiometric air/fuel ratio.

10. An evaporative emissions control system for an internal combustion engine comprising:
a fuel vapor absorption device including a material configured to adsorb fuel vapors that have evaporated from fuel stored in a fuel tank;
a plurality of engine cylinders, one of which is a dedicated exhaust gas recirculation (DEGR) cylinder;
a fuel tank vent line configured to direct fuel vapors to only the DEGR cylinder, and not the other plurality of cylinders;
a purge valve along the fuel tank vent line;
a controller configured to:
open the purge valve when engine temperature is greater than a predetermined threshold to direct fuel vapors to only the DEGR cylinder to be burned by the internal combustion engine to run the DEGR cylinder at a rich stoichiometric air/fuel ratio; and
run the plurality of cylinders other than the DEGR cylinder at a stoichiometric air/fuel ratio.

11. The evaporative emissions control system of claim 10, further comprising a hydrocarbon sensor along the fuel tank vent line;
wherein the controller receives inputs from the hydrocarbon sensor identifying the amount of fuel vapor exiting the fuel vapor absorption device, and the controller is configured to operate the purge valve based on the inputs to run the DEGR cylinder at a rich stoichiometric air/fuel ratio.

12. The evaporative emissions control system of claim 10, further comprising a check valve between the purge valve and the DEGR cylinder.

13. The evaporative emissions control system of claim 10, further comprising a vapor management valve between the fuel tank and the fuel vapor absorption device that is configured to restrict passage of liquid fuel to the fuel vapor absorption device from the fuel tank.

14. The evaporative emissions control system of claim 10, further comprising an air inlet at the fuel vapor adsorption device configured to permit air to pass therethrough to mix with the fuel vapors.

15. The evaporative emissions control system of claim 10, wherein the fuel tank vent line extends directly from the fuel vapor absorption device.

16. The evaporative emissions control system of claim 10, further comprising a compressor and a turbine of a turbocharger.

17. A method for operating an internal combustion engine having a plurality of cylinders, one of which is a dedicated exhaust gas recirculation (DEGR) cylinder, the method comprising:
opening a purge valve along a fuel tank vent line to permit fuel vapor evaporated from the fuel tank to flow through the fuel tank vent line to only the DEGR cylinder of the plurality of cylinders to run the DEGR cylinder at a rich stoichiometric air/fuel ratio, and run the plurality of cylinders other than the DEGR cylinder at a stoichiometric air/fuel ratio.

18. The method of claim 17, further comprising opening the purge valve when temperature of the internal combustion engine is above a predetermined threshold.

19. The method of claim 17, further comprising operating the purge valve based on inputs from a hydrocarbon sensor along the fuel tank vent line.

20. The method of claim 17, wherein the purge value is operated by a controller configured to run the DEGR cylinder at a rich stoichiometric air/fuel ratio, and run the plurality of cylinders other than the DEGR cylinder at a stoichiometric air/fuel ratio; and
wherein a purge pump is arranged upstream or downstream of the purge valve.
